(19) United States
(12) Patent Application Publication
(10) Pub. No.: US 2015/0092516 A1
(43) Pub. Date: Apr. 2, 2015

(54) DETERMINING THE POSITION OF SEISMIC EQUIPMENT USING PINGERS

(71) Applicant: WESTERNGECO L.L.C., HOUSTON, TX (US)

(72) Inventors: SVEIN ARNE FRIVIK, OSLO (NO); LEENDERT COMBEE, SANDVIKA (NO)

(21) Appl. No.: 14/496,405

(22) Filed: Sep. 25, 2014

Related U.S. Application Data
(60) Provisional application No. 61/885,311, filed on Oct. 1, 2013.

(51) Int. Cl. G01V 1/38

(52) U.S. Cl. CPC G01V 1/38
USPC 367/14

(57) ABSTRACT

A method for transmitting acoustic signals from pingers. The method includes transmitting acoustic signals from a first group of pingers within a seismic spread. The method includes transmitting acoustic signals from a second group of pingers within the seismic spread after a predetermined amount of time has passed, wherein the signals from the first group and the second group are emitted between two seismic shots. The first group of pingers and the second group of pingers are mutually exclusive.

### CROSS-REFERENCE TO RELATED APPLICATION

This application claims the benefit of U.S. Provisional Patent Application Ser. No. 61/885311 filed Oct. 1, 2013, which is incorporated herein by reference in its entirety.

### BACKGROUND

### Discussion of the Related Art

This section is intended to provide background information to facilitate a better understanding of various technologies described herein. As the section's title implies, this is a discussion of related art. That such art is related in no way implies that it is prior art. The related art may or may not be prior art. It should therefore be understood that the statements in this section are to be read in this light, and not as admissions of prior art.

Seismic surveys can be conducted at sea, on shore, or in zones between sea and shore, e.g., in shallow bays, in swampy areas, and the like. A common feature of the surveys is that a seismic signal is transmitted from a seismic source and this signal is reflected by the ground formation and proceeds to be intercepted by seismic sensors. The seismic signals are then transmitted to an appropriate receiver station, where these data are processed and stored, and used for constructing structural maps of the rock formations. These maps facilitate the process of assessing the probability of the existence of oil or gas in the surveyed area.

In marine surveys, where it is the seabed that has to be surveyed, a typical seismic tow will consist of one or more sources and one or more cables, also called streamers. The actual towing is performed by one or more vessels. The seismic equipment towed behind the vessels is usually submerged in the water. A streamer generally extends to a length of from a few hundred meters to several thousand meters. Inside the streamer, there are located a large number of acoustic sensors, also called hydrophones. A source usually consists of several suitable sonic guns, for example, air guns, which are arranged in a row or in a group. This is also called a gun array. When air guns are used, the guns are filled with compressed air, this air being released at a given time, thereby forming the seismic pulse. This is also called a seismic shot, or a shot point. It is this pulse, which, after having been reflected, is intercepted by sensors in the seismic streamer. A marine vibrator can also be used as a source. In a streamer of approximately 3,000 meters there can be from several hundred to over a thousand sensors. This means that the sensors may be situated close to one another.

### SUMMARY

Described herein are implementations of various technologies for a method of transmitting acoustic signals from pingers. The method may include transmitting acoustic signals from a first group of pingers within a seismic spread. The method may include transmitting acoustic signals from a second group of pingers within the seismic spread after a predetermined amount of time has passed, wherein the signals from the first group and the second group are emitted between two seismic shots. The first group of pingers and the second group of pingers may be mutually exclusive.

Described herein are also implementations of various technologies for a method of deploying groups of pingers within a seismic spread. The method may include deploying a first group of pingers within a seismic spread, wherein the first group of pingers are assigned a first code. The method may include deploying a second group of pingers within the seismic spread, wherein the second group of pingers are assigned a second code that is different from the first code, and wherein the distance between pingers in the second group is greater than the distance between pingers in the first group. The first code and the second code may be different codes.

Described herein are also implementations of various technologies for a method of transmitting signals from a subset of pingers within a seismic spread. The method may include deploying a set of pingers within a seismic spread, wherein the set of pingers are divided into a first subset and a second subset that are mutually exclusive of each other, and wherein the first subset and the second subset are divided based on acoustic propagation of the area in which the seismic spread is located. The method may include transmitting acoustic signals from only the first subset between two seismic shots.

The above referenced summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Implementations of various technologies will hereafter be described with reference to the accompanying drawings. It should be understood, however, that the accompanying drawings illustrate only the various implementations described herein and are not meant to limit the scope of various technologies described herein.

FIG. 1 illustrates a top view an implementation of a seismic surveying system in accordance with implementations of various techniques described herein.

FIG. 2 is a diagram of activated and deactivated pingers in accordance with implementations of various techniques described herein.

FIG. 3 is a diagram of multiple groups of pingers in accordance with implementations of various techniques described herein.

FIG. 4 is a diagram of coded pingers in accordance with implementations of various techniques described herein.

FIG. 5 is a diagram of coded pingers in accordance with implementations of various techniques described herein.

FIG. 6 illustrates a schematic diagram of a computing system in which the various technologies described herein may be incorporated and practiced.

### DETAILED DESCRIPTION

The discussion below is directed to certain specific implementations. It is to be understood that the discussion below is only for the purpose of enabling a person with ordinary skill in the art to make and use any subject matter defined now or later by the patent “claims” found in any issued patent herein.

It is specifically intended that the claimed invention not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

Reference will now be made in detail to various implementations, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the embodiments.

It will also be understood that, although the terms first, second, etc., may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down;” “upper” and “lower;” “upwardly” and “downwardly;” “below” and “above;” and other similar terms indicating relative positions above or below a given point or element may be used in connection with some implementations of various technologies described herein.

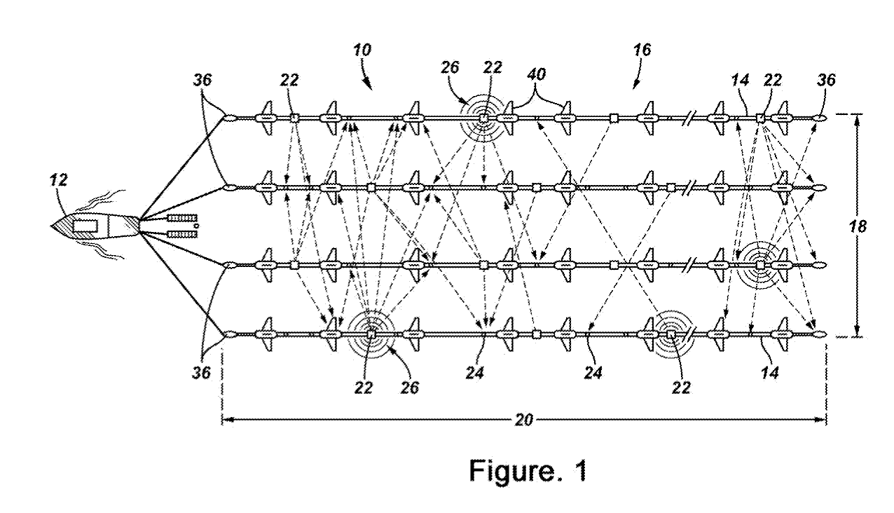

Various implementations described herein will now be described in more detail with reference to FIGS. 1-6.

FIG. 1 is a top view of an implementation of a seismic surveying system, generally denoted by the numeral 10. System 10 may be an acoustic ranging system. System 10 includes a vessel 12 towing one or more streamers 14. Streamers 14 extend longitudinally from vessel 12 and are spaced from one another laterally to form a seismic spread 16 for conducting a seismic survey. It is not uncommon for seismic spread 16 to extend 300 to 1200 meters laterally, denoted 18, and to extend longitudinally 3 to 12 kilometers, denoted 20. Proximate the distal ends of streamer 14 are global positioning systems 36. Birds 40, carrying instruments to provide dynamic information regarding the position of streamer 14, may also be connected along streamer 14.

Seismic spread 16 includes an acoustic ranging system for navigation and positioning purposes. The acoustic ranging system includes a plurality of transmitters, hereinafter referred to as pingers 22, and receivers 24. The acoustic ranging system measures the range between pingers 22 and receivers 24. The range is the travel time of a direct arrival of a signal 26 transmitted from a pinger 22 and received by a receiver 24.

Calculation of positions for the seismic equipment or the receivers 24 can be performed in different ways depending on which parameters are known for the system and how the system is configured. In one implementation, the received pinger signals 26 are cross-correlated with the transmitting signal signature of the specific pingers 22 to which the absolute or relative distance is required to be determined. Further processing of data may then be performed. In one example, a system with a pinger 22 and a receiver 24 may record the time at which the pinger 22 transmits a signal 26. For each transmission from the pinger 22, the system may determine the time difference between when a signal 26 is transmitted by the pinger 22 and received by the receiver 24. This technique may be used on streamers 14 with multiple pingers 22 and receivers 24 in order to continuously determine a geometrical network of distances and relative positions throughout a seismic survey.

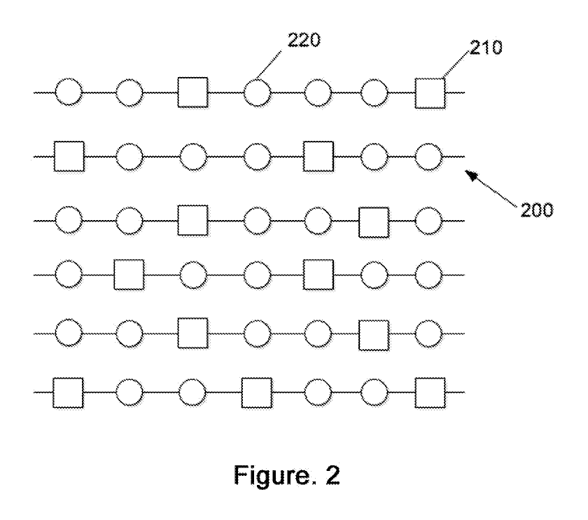

The pingers 22 may be arranged within the seismic spread 16 in any configuration. In one implementation, the pingers 22 may be arranged in a regular grid. A regular grid may be a grid in which each pinger is at the same offset on the streamers 14, or the pingers are at the same offsets on alternating streamers. For example, in one regular grid a pinger 22 may be placed at the same offset on every streamer 14 FIGS. 2-5 are examples of this type of regularly spaced grid of pingers 22. In another example of a regular grid, the pingers 22 may be interlaced, i.e., alternating streamers 14 have pingers 22 with the same offsets. FIG. 1 is an example of this type of regular grid, where, the first and third streamers 14 have pingers 22 with the same offsets, and the second and fourth streamers 14 have pingers 22 with the same offsets, but the offsets in the second and fourth streamers are different from those in the first and third streamers.

The pingers 22 may transmit an encoded signal 26 on command. The receivers 24 may intercept the signal 26 and transmit it to the vessel 12 for processing and storing. The encoded signals 26 from the pingers 22 may be recorded at any time. For example this can be done during the normal recording time for a shot, or also between each seismic shot. Encoded signals 26 are normally recorded and stored during a period of 4 to 12 seconds after a shot has been fired. Seismic signals from a seismic shot and encoded signals 26 from pingers 22 may be recorded simultaneously and then separated by frequency.

The number of unique codes that may be used to encode the signals 26 depends on the length of the signals 26 transmitted by the pingers 22. Signals 26 transmitted using the same codes may interfere with each other, causing noise, also known as code overlap. This may occur when signals 26 with the same code are received around the same time. For example, if two pingers 22 use the same code, and both are 300 m from a receiver 24, the signals 26 may reach the receiver 24 at approximately the same time. Thus the received signals 26 may not be used for positioning due to interference, i.e., the receiver 24 cannot determine which signal 26 is from which pinger 22. In a second example, if two pingers 22 use the same code, and one is 300 m from a receiver 24 and the other is 1500 m from the receiver 24, the receiver 24 may be able to use both signals 26 because they will arrive at different times, i.e., the receiver 24 will be able to determine which signal 26 is from which pinger 22. When interference occurs, the precision of positions calculated using signals 26 decreases. FIGS. 2-4 illustrate methods that may be used to reduce interference in signals 26 transmitted by pingers 22.

FIG. 2 is a diagram of activated and deactivated pingers in accordance with implementations of various techniques described herein. Streamers 200 may include activated pingers 210 (squares) and deactivated pingers 220 (circles). In some instances, deactivating a selection of pingers within a seismic spread may decrease interference between the signals transmitted by the activated pingers, thereby increasing the precision of positioning calculations. The pingers may be activated and deactivated remotely. For example, pingers on streamers 200 may be activated or deactivated from a vessel 12. Additionally, the code assigned to each pinger may be changed remotely. Pingers may be activated, deactivated, or assigned a code before or during a seismic survey. The pingers may be positioned on the streamers 200 in a regular grid, or in any other configuration.

In one implementation, streamers 200 may include more pingers than the minimum number of pingers needed to determine the positions of the seismic equipment. The set of all pingers on the streamers 200 may be divided into two subsets, i.e., an activated subset containing pingers 210 and a deactivated subset containing pingers 220. The activated set of pingers may include the minimum number of pingers needed to determine the positions of the seismic equipment. The two subsets are mutually exclusive, where a pinger can either be in the activated subset, or the deactivated subset, but not both. The subsets may include all of the pingers on the streamers 200 so that every pinger on the streamers 200 must be either in the activated subset or the deactivated subset. Then, between two seismic shots, acoustic signals may be transmitted using only the activated set of pingers. These acoustic signals may be transmitted simultaneously or substantially simultaneously.

One factor that may be used to determine which pingers should be activated and deactivated is the acoustic propagation of an area. The acoustic propagation of an area may be affected by many factors, including bubbles in the water column generated by the seismic source, density layering in the water column causing refraction and reflection of the acoustic energy, and interference from bottom reflected signals.

In one implementation, the acoustic propagation of an area may be determined or estimated. Then, an optimal distance between pingers with the same code may be determined. The optimal distance may be a distance calculated to reduce interference between pingers with the same codes. For example, if the acoustic propagation of a signal in the area is 500 m, the optimal distance may be 1000 m apart. Two subsets of pingers may then be created, an activated subset, and a deactivated subset. The activated subset may be selected so that no two pingers with the same code in the activated subset are within 1000 m of each other. Then, acoustic signals may be transmitted from the activated subset only, and not the deactivated subset.

In a second implementation, the pingers may be activated, deactivated, and assigned different codes during a seismic survey, using data from the receivers. A user or computer system may evaluate which pingers are unnecessary and causing interference, and then deactivate those pingers. Alternately, instead of deactivating a pinger, the pinger may be assigned a different code. By activating pingers that are giving the best results and deactivating the pingers that are causing interference, more precise positioning data may be obtained.

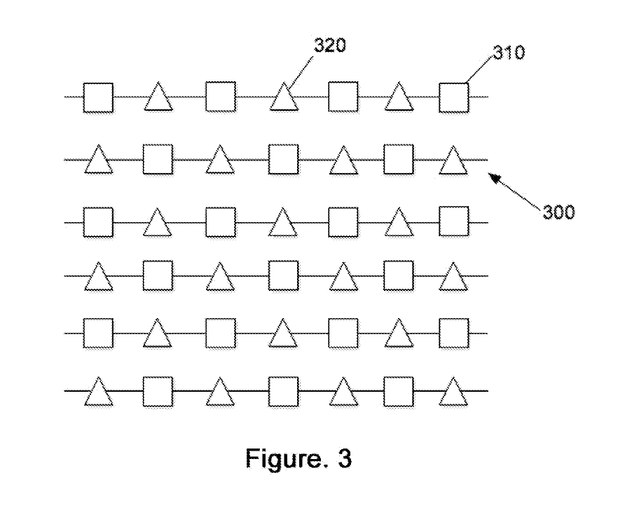

FIG. 3 is a diagram of multiple groups of pingers in accordance with implementations of various techniques described herein. Streamers 300 may contain pingers 310 and 320. The pingers may be placed into two groups, pingers 310 (square) may form a first group, and pingers 320 (triangle) may form a second group. Between seismic shots, the first group composed of pingers 310 may transmit signals, then, after a predetermined delay, the second group composed of pingers 320 may transmit signals. The predetermined delay may be selected in order to allow the transmissions from pingers 310 to dissipate prior to the transmission of signals from pingers 320. The delay may reduce or eliminate interference between the transmissions from pingers 310 and the transmissions from pingers 320. The groups may be selected or positioned so that pingers whose signals interfere with each other when transmitted simultaneously may be placed in separate groups and not transmitted simultaneously, thus no longer interfering with each other.

The pingers 310 and 320 may be in a regular grid, or in any other arrangement on the streamers 300. Additionally, the illustrated pingers may alternate between groups in a regular manner, but they may be distributed irregularly between groups. Although FIG. 3 illustrates the pingers divided into two groups, the pingers may be divided into any number of groups. The groups may contain all of the pingers on the streamers 300, or there may be deactivated pingers that are not in any group, and that do not transmit seismic signals.

The groups may be selected prior to the beginning of a seismic survey or during a seismic survey. For example, the groups may be selected using data from the receivers. In this example, during a seismic survey, pingers whose signals are interfering with each other when transmitted simultaneously may be placed in separate groups and not transmitted simultaneously, thus no longer interfering with each other. Alternately, one pinger may be assigned a different code.

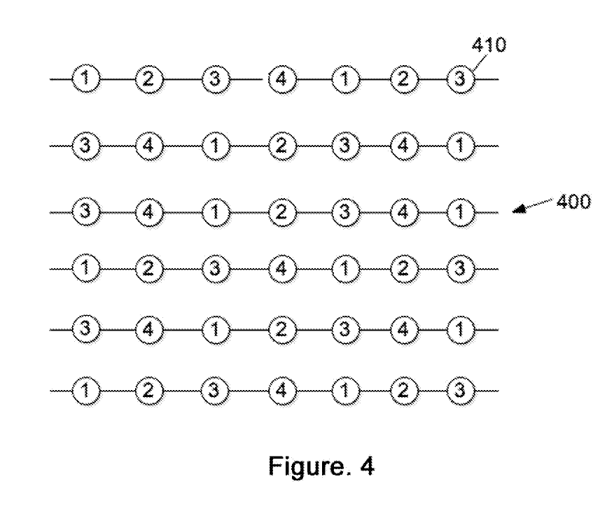

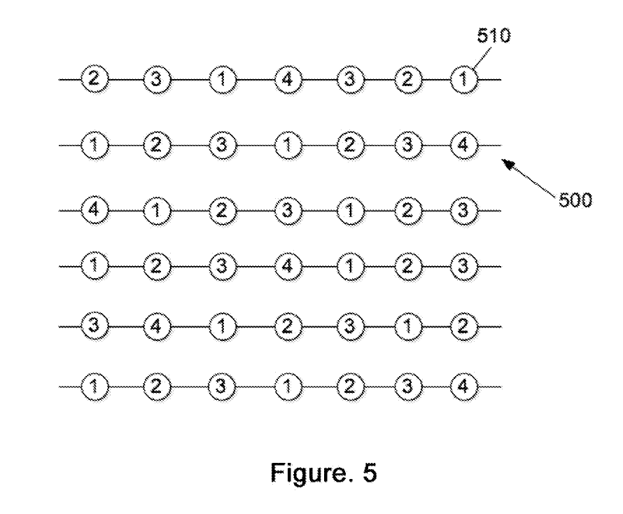

Codes may be assigned to the pingers before or after groups are selected, or both. Codes may be distributed evenly among the pingers, or evenly among the groups. Additionally, codes may be distributed so that some codes are used more than others, as described in FIGS. 4 and 5.

In one implementation, the groups may be selected using the acoustic propagation of the area in which the survey is conducted. For example, if the propagation of a signal in the area is 500 m, the optimal distance between pingers with the same code may be 1000 m apart. The pingers may then be divided into any number of groups so that no group contains two pingers with the same code that are less than 1000 m apart. Then, a delay may be selected, where the delay is long enough to allow the transmissions from the groups of pingers to dissipate prior to the transmissions from the next group. Finally, between two seismic shots, the pingers in the first group may transmit signals simultaneously or substantially simultaneously, then, after the delay, the pingers in the second group may transmit signals, and then, after the delay, the pingers in the third group may transmit signals, and continuing until all groups have transmitted signals.

FIGS. 4 and 5 are diagrams of coded pingers in accordance with implementations of various techniques described herein. Pingers 410 are located on streamers 400. In order to decrease interference between signals, some codes may be assigned to less pingers 410 than other codes. The pingers 410 may be distributed regularly on the streamers 400, or in any other configuration. Pingers 410 may be activated, deactivated, or be assigned codes before or during a seismic survey. Pingers 410 may transmit acoustic signals simultaneously between seismic shots.

In one implementation, pingers 410 within a seismic spread may be divided into two groups, where the first group contains more pingers 410 than the second group. Thus, the average distance between pingers 410 within the first group may be less than the average distance between pingers 410 in the second group. Then, a first code may be assigned to the pingers 410 in the first group, and a second code may be assigned to the pingers 410 in the second group. The first code is thus more dense than the second code because the average distance between pingers assigned the first code will be smaller than the average distance between pingers assigned the second code. The density selected for the codes may be selected using the acoustic propagation of an area.

Transmissions from the second group of pingers 410 may be received at a longer distance than those from the first group of pingers 410, because the second code is less dense. Compared to an even distribution, the average distance between pingers in the first group may be less, whereas the average distance between pingers in the second group may be greater. This uneven distribution of codes may allow for more precise positioning data to be obtained. FIG. 4 illustrates one example of an arrangement of coded pingers. Codes 2 and 4 are assigned to 9 pingers 410 each, while codes 1 and 3 are assigned to 12 pingers 410 each. Thus, the signals transmitted from pingers assigned codes 2 and 4 may be received at a greater distance than the signals transmitted from pingers assigned codes 1 and 3, because codes 1 and 3 are more dense than codes 2 and 4.

FIG. 5 illustrates a second example of an arrangement of coded pingers. Codes 1, 2, and 3 are assigned to twelve pingers 510 each, while code 4 is assigned to six pingers 510. Thus, the signals transmitted from pingers assigned code 4 may be received at a greater distance than the signals transmitted from pingers assigned codes 1, 2, and 3.

### Computing System

Implementations of various technologies described herein may be operational with numerous general purpose or special purpose computing system environments or configurations. Examples of well known computing systems, environments, and/or configurations that may be suitable for use with the various technologies described herein include, but are not limited to, personal computers, server computers, hand-held or laptop devices, multiprocessor systems, microprocessor-based systems, set top boxes, programmable consumer electronics, network PCs, minicomputers, mainframe computers, and the like.

The various technologies described herein may be implemented in the general context of computer-executable instructions, such as program modules, being executed by a computer. Generally, program modules include routines, programs, objects, components, data structures, etc., that perform particular tasks or implement particular abstract data types. Further, each program module may be implemented in its own way, and all need not be implemented the same way. While program modules may all execute on a single computing system, it should be appreciated that, in some implementations, program modules may be implemented on separate computing systems or devices adapted to communicate with one another. A program module may also be some combination of hardware and software where particular tasks performed by the program module may be done either through hardware, software, or both.

The various technologies described herein may also be implemented in distributed computing environments where tasks are performed by remote processing devices that are linked through a communications network, e.g., by hardwired links, wireless links, or combinations thereof. In a distributed computing environment, program modules may be located in both local and remote computer storage media including memory storage devices.

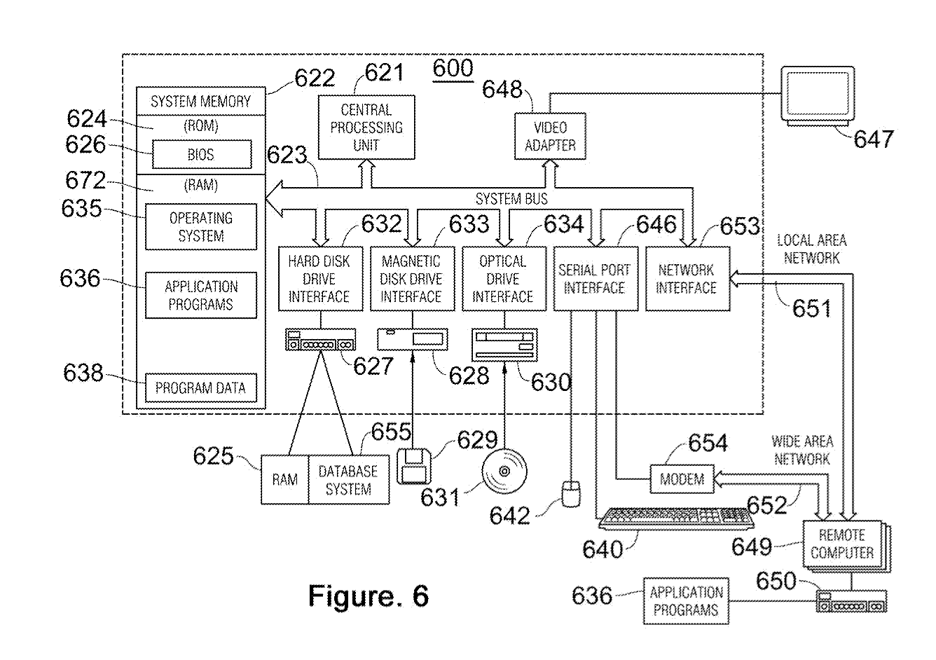

FIG. 6 illustrates a computer system 600 into which implementations of various technologies and techniques described herein may be implemented. Computing system 600 may be a conventional desktop, a handheld device, a controller, a server computer, an electronic device/instrument, a laptop, a tablet, or part of a seismic survey system. It should be noted, however, that other computer system configurations may be used.

The computing system 600 may include a central processing unit (CPU) 621, a system memory 622 and a system bus 623 that couples various system components including the system memory 622 to the CPU 621. Although only one CPU is illustrated in FIG. 6, it should be understood that in some implementations the computing system 600 may include more than one CPU. The system bus 623 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 622 may include a read only memory (ROM) 624 and a random access memory (RAM) 625. A basic input/output system (BIOS) 626, containing the basic routines that help transfer information between elements within the computing system 600, such as during start-up, may be stored in the ROM 624. The computing system may be implemented using a printed circuit board containing various components including processing units, data storage memory, and connectors.

The computing system 600 may further include a hard disk drive 627 for reading from and writing to a hard disk, a magnetic disk drive 628 for reading from and writing to a removable magnetic disk 629, and an optical disk drive 630 for reading from and writing to a removable optical disk 631, such as a CD ROM or other optical media. The hard disk drive 627, the magnetic disk drive 628, and the optical disk drive 630 may be connected to the system bus 623 by a hard disk drive interface 632, a magnetic disk drive interface 633, and an optical drive interface 634, respectively. The drives and their associated computer-readable media may provide nonvolatile storage of computer-readable instructions, data structures, program modules and other data for the computing system 600.

Although the computing system 600 is described herein as having a hard disk, a removable magnetic disk 629 and a removable optical disk 631, it should be appreciated by those skilled in the art that the computing system 600 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 600. Communication media may embody computer readable instructions, data structures, program modules or other data in a modulated data signal, such as a carrier wave or other transport mechanism and may include any information delivery media. By way of example, and not limitation, communication media may include wired media such as a wired network or direct-wired connection, and wireless media such as acoustic, RF, infrared and other wireless media. Combinations of any of the above may also be included within the scope of computer readable media.

A number of program modules may be stored on the hard disk 627, magnetic disk 629, optical disk 631, ROM 624 or RAM 625, including an operating system 635, one or more application programs 636, program data 638, and a database system 655. The one or more application programs 636 may contain program instructions configured to select groups of pingers to activate and deactivate as described in FIG. 2, select groups of pingers as illustrated in FIG. 3, and select a distribution of codes as described in FIGS. 4 and 5 according to various implementations described herein. The operating system 535 may be any suitable operating system that may control the operation of a networked personal or server computer, such as Windows® XP, Mac OS® X, Unix-variants (e.g., Linux® and BSD®), and the like.

A user may enter commands and information into the computing system 600 through input devices such as a keyboard 640 and pointing device 642. Other input devices may include a microphone, joystick, game pad, satellite dish, scanner, user input button, or the like. These and other input devices may be connected to the CPU 621 through a serial port interface 646 coupled to system bus 623, but may be connected by other interfaces, such as a parallel port, game port or a universal serial bus (USB). A monitor 647 or other type of display device may also be connected to system bus 623 via an interface, such as a video adapter 648. In addition to the monitor 647, the computing system 600 may further include other peripheral output devices such as speakers and printers.

Further, the computing system 600 may operate in a networked environment using logical connections to one or more remote computers 649. The logical connections may be any connection that is commonplace in offices, enterprise-wide computer networks, intranets, and the Internet, such as local area network (LAN) 651 and a wide area network (WAN) 652. The remote computers 649 may each include application programs 636 similar to that as described above.

When using a LAN networking environment, the computing system 600 may be connected to the local network 651 through a network interface or adapter 653. When used in a WAN networking environment, the computing system 600 may include a modem 654, wireless router or other means for establishing communication over a wide area network 652, such as the Internet. The modem 654, which may be internal or external, may be connected to the system bus 623 via the serial port interface 646. In a networked environment, program modules depicted relative to the computing system 600, or portions thereof, may be stored in a remote memory storage device 650. It will be appreciated that the network connections shown are exemplary and other means of establishing a communications link between the computers may be used.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, comprising:
transmitting acoustic signals from a first group of pingers within a seismic spread; and
transmitting acoustic signals from a second group of pingers within the seismic spread after a predetermined amount of time has passed, wherein the signals from the first group and the second group are emitted between two seismic shots; and
wherein the first group of pingers and the second group of pingers are mutually exclusive.

2. The method of claim 1, wherein the predetermined amount of time is selected to reduce interference between the transmission of the first group and the transmission of the second group.

3. The method of claim 1, further comprising:
determining the acoustic propagation of the area where the seismic spread is located; and
positioning the first group of pingers and the second group of pingers based on the acoustic propagation.

4. The method of claim 1, further comprising:
determining the acoustic propagation of the area where the seismic spread is located; and
selecting the first group of pingers and the second group of pingers based on the acoustic propagation.

5. The method of claim 1, further comprising:
assigning a first code to a first subgroup of pingers within the first group of pingers; and
assigning a second code to a second subgroup of pingers within the first group of pingers;
wherein the first subgroup contains more pingers than the second subgroup, and the first code is different than the second code.

6. The method of claim 1, wherein the number of pingers in the first group is different from the number of pingers in the second group.

7. The method of claim 1, wherein the pingers are arranged in a regular grid.

8. The method of claim 1, wherein alternating streamers within the seismic spread have the same distribution of pingers.

9. The method of claim 1, wherein the predetermined amount of time is between about 0.1 second and about 0.5 second.

10. The method of claim 1, wherein alternating pingers on a streamer are placed in alternating groups.

11. A method, comprising:
deploying a first group of pingers within a seismic spread, wherein the first group of pingers are assigned a first code;
deploying a second group of pingers within the seismic spread, wherein the second group of pingers are assigned a second code that is different from the first code, wherein the distance between pingers in the second group is greater than the distance between pingers in the first group; and
wherein the first code and the second code are different codes.

12. The method of claim 11, wherein the number of pingers in the second group is smaller than the number of pingers in the first group.

13. The method of claim 11, wherein the pingers are arranged in a regular grid.

14. The method of claim 11, further comprising transmitting acoustic signals from both the first and second groups substantially simultaneously.

15. The method of claim 11, further comprising:
transmitting acoustic signals from a first pinger in the first group of pingers and a first pinger in the second group of pingers; and
after a predetermined amount of time has passed, transmitting acoustic signals from a second pinger in the first group of pingers and a second pinger in the second group of pingers, wherein the signals from the first pingers and the second pingers are emitted between two seismic shots.

16. A method, comprising:
deploying a set of pingers within a seismic spread, wherein the set of pingers are divided into a first subset and a second subset that are mutually exclusive of each other, wherein the first subset and the second subset are divided based on acoustic propagation of the area in which the seismic spread is located; and
transmitting acoustic signals from only the first subset between two seismic shots.

17. The method of claim 16, wherein the pingers are arranged in a regular grid.

18. The method of claim 16, wherein alternating streamers within the seismic spread have the same distribution of pingers.

19. The method of claim 16, further comprising deactivating one or more pingers during a seismic survey.

20. The method of claim 16, wherein the pingers in the first subset transmit signals substantially simultaneously.
